(19) United States
(12) Patent Application Publication
(10) Pub. No.: US 2017/0350495 A1
(43) Pub. Date: Dec. 7, 2017

(54) FINAL DRIVE HOUSING

(71) Applicant: Caterpillar SARL, Geneva (CH)

(72) Inventors: Seiji Iijima, Tokyo (JP); Takayuki Shiokawa, Tokyo (JP); Junichi Furukawa, Hyogo (JP)

(73) Assignee: Caterpillar SARL, Geneva (CH)

(21) Appl. No.: 15/610,903

(22) Filed: Jun. 1, 2017

(30) Foreign Application Priority Data
Jun. 1, 2016 (JP) 2016-110282

(51) Int. Cl. F16H 57/029; B62D 55/125; B60K 17/04

(52) U.S. Cl. CPC F16H 57/029; B60K 17/046; B62D 55/125

(57) ABSTRACT

A housing for a final drive, the housing being capable of reducing invasion of foreign materials into a labyrinth channel by a simple configuration, and easily discharging out foreign materials in the labyrinth channel, and a final drive provided with the housing. A labyrinth channel 52 is provided at a position facing a floating seal 51 for sealing a gap between a stationary-side housing 26 and a rotation-side housing 25. Slits 39 for discharging out foreign materials are provided. The slits 39 communicate with the labyrinth channel 52 and are provided around an outer periphery portion of a cylinder-shaped housing main body 38 of the stationary-side housing 26 in such a way that the slits 39 are located in an area located in a lower part or one edge portion along the driving direction in a lower half portion of the housing main body 38.

### FIELD OF THE INVENTION

The present disclosure relates to a housing for a final drive, the housing being configured for housing a deceleration mechanism for decelerated transmission of a rotation speed of a driving motor, and to a final drive equipped with the same.

### BACKGROUND

Conventionally, a driving device for use in a crawler vehicle such as a hydraulic excavator is equipped with a final drive, which functions to perform decelerated transmission of a rotation speed of a driving motor to a crawler track (while increasing torque). The final drive is constituted by a deceleration mechanism such as a planetary gear arrangement inside a housing including a stationary-side housing fixed to a crawler track frame and a rotation-side housing freely rotatable with respect to the stationary-side housing.

In such a configuration, a sliding portion between the stationary-side housing and the rotation-side housing is provided with a floating seal for preventing leakage of lubricant oil from the deceleration mechanism. Configurations for avoiding damage to the floating seal due to clogging of the crawler track with foreign materials such as mud are known, such as a labyrinth channel communicating with the area outside the floating seal, in order to reduce the invasion of foreign materials. Japanese Patent Application Publication No. 50-258, discloses a discharge ditch for discharging out fine foreign materials invaded into the labyrinth channel provided around the whole periphery of the stationary-side housing. An upper portion of the stationary-side housing is covered with an arc-shaped wall portion in order to reduce the invasion of foreign materials, such as small stones, falling down from the crawler track located above the stationary-side housing. However, this configuration is not sufficient to reduce foreign materials conveyed from the crawler track located below the final drive. Other known configurations include forming a slope in the stationary-side housing in a range of +/−30° to provide a tapered entry to the labyrinth channel, or forming the the labyrinth channel such that the gap in the lower portion is larger than a gap in the upper portion, in order to facilitate the discharge of foreign material invaded therein.

However, these configurations are not sufficient to reduce the invasion of foreign materials, because the labyrinth channel itself is the only configuration for hampering the invasion of foreign materials.

As such, there is a demand for a simpler configuration that can more effectively reduce the invasion of foreign materials and the seal destruction caused by the invading foreign materials.

### SUMMARY

A housing for a final drive is provided, the housing being configured to be positioned at one end of a driving device of a crawler vehicle in a driving direction and for housing a deceleration mechanism for decelerated transmission of a rotation of a driving motor to a crawler track, comprising: a stationary-side housing; a rotation-side housing provided rotatably with respect to the stationary-side housing and configured such that the crawler track of the driving device is to be wound around the rotation-side housing; a seal portion for sealing a gap between the stationary-side housing and a rotation-side housing; and a labyrinth channel provided at a position corresponding to the seal portion, the stationary-side housing having: a cylinder-shaped housing main body located coaxially with a rotation shaft of the rotation-side housing; and a plurality of openings for discharging foreign materials, the plurality of openings being provided in a lower half portion of the housing main body.

According to the disclosed embodiment, the plurality of openings for discharging foreign materials are provided only in around an outer periphery portion of the lower half portion of the cylindrical-shaped housing main body of the stationary-side housing so as to communicate with the labyrinth channel, whereby it becomes possible to reduce invasion of foreign materials into the labyrinth channel by such a simple configuration and to easily discharge, via the openings, foreign materials invaded into the labyrinth channel.

### BRIEF DESCRIPTION OF DRAWINGS

FIG. 1(a) is a side view illustrating one embodiment of a final drive according to the present invention, and FIG. 1(b) is a cross-sectional view illustrating part of the final drive.

FIG. 2 is a front view illustrating the housing.

FIG. 3 is a perspective view illustrating part of a driving device provided with the final drive housing.

FIG. 4 is a side view illustrating a crawler vehicle provided with the housing.

### DETAILED DESCRIPTION

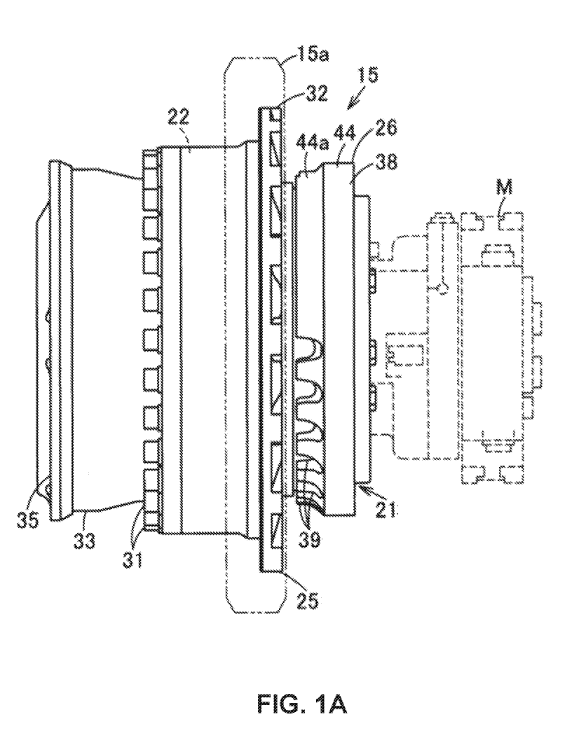

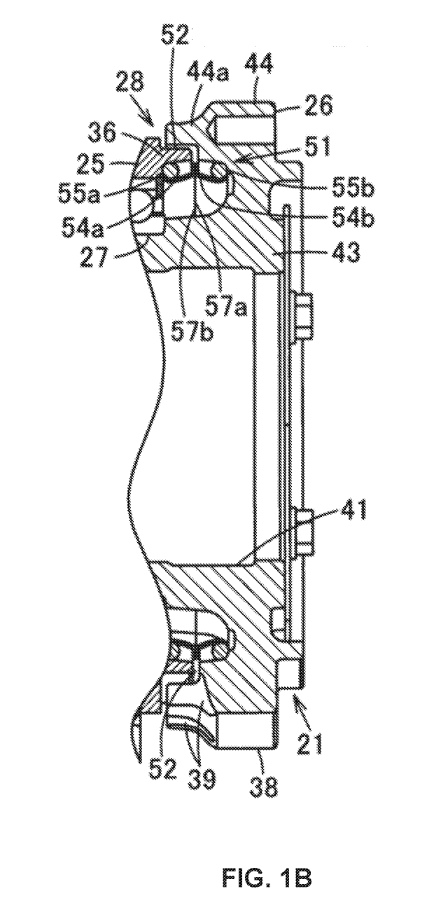

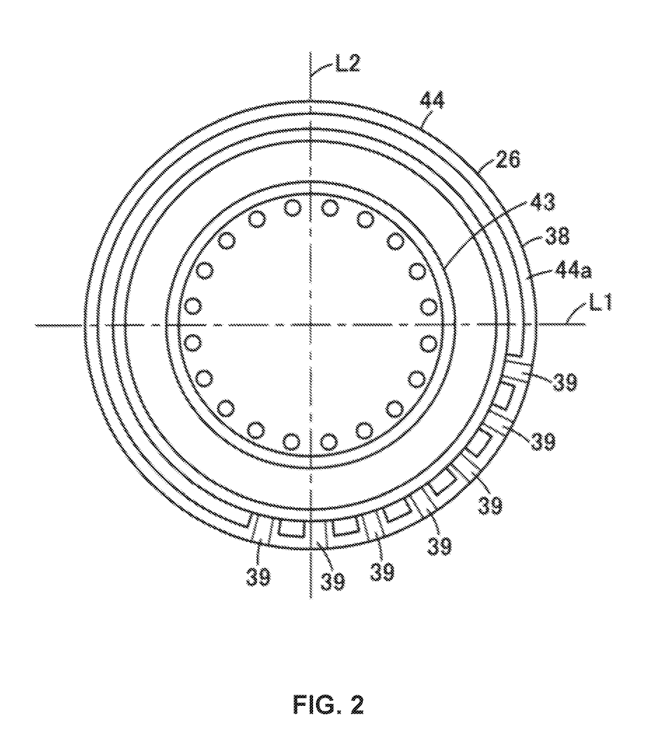

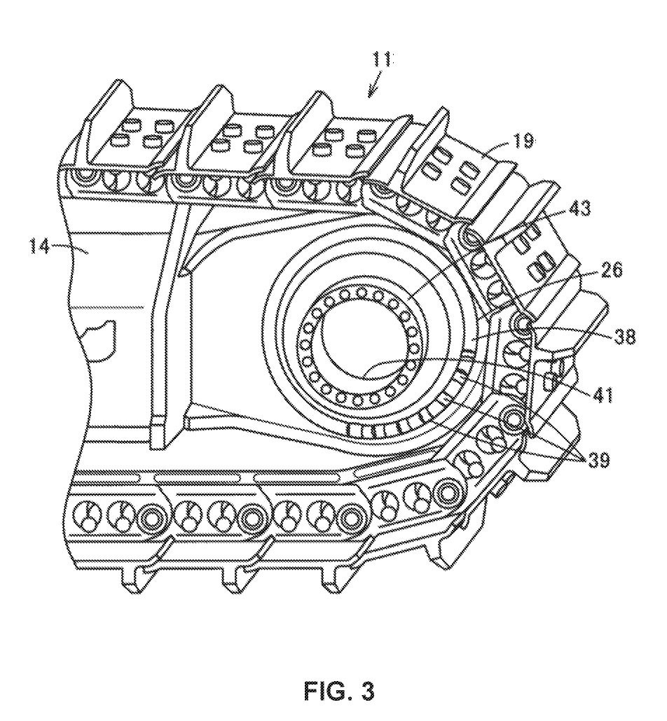

In the following, the present disclosure is described in detail, referring to one embodiment illustrated in FIGS. 1 to 4.

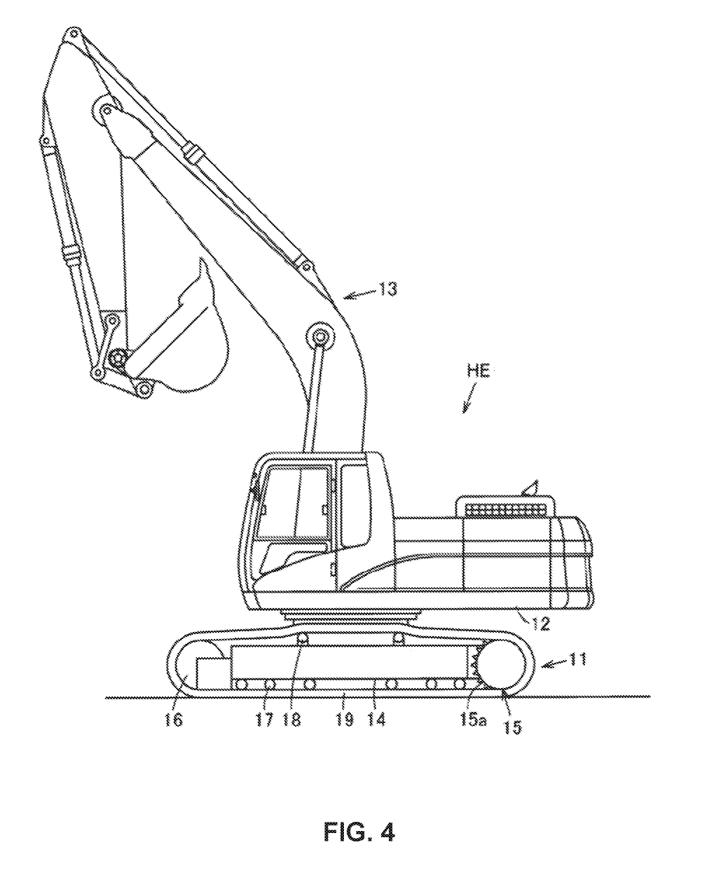

As illustrated in FIG. 4, a hydraulic excavator serving as a working machine is a crawler vehicle and includes an upper rotatable body 12 rotatably mounted on a driving device 11 provided below the rotatable body, and a working device 13 for construction work or the like device mounted on the upper rotatable body 12.

The driving device 11 includes a sprocket 15a of a final drive 15 on one end (rear) of a crawler frame 14 in a driving direction, the crawler frame 14 being provided on each of a right side and a left side of the vehicle, and the final drive being configured to be driven by a driving hydraulic motor, that is, a driving motor M (FIG. 1(a)). At each of the other ends (front), an idler wheel 16 is rotatably supported by a shaft. In a lower portion of the crawler frame, a plurality of lower rollers 17 are rotatably supported by respective shafts. In an upper portion of the crawler frame a plurality of upper rollers 18 are rotatably supported by respective shafts. A crawler track 19 is wound on the sprocket 15a, the idler wheel 16, the plurality of lower rollers 17, and upper rollers 18 on either of left and right sides of the vehicle. Note that FIGS. 1 to 4 illustrate only the left side of the vehicle and illustration of the right side of the vehicle is omitted here as the right and left sides are symmetrical.

As illustrated in FIGS. 1 to 4, the final drive 15 includes a housing 21 and a deceleration mechanism 22 housed in (built in) the housing 21.

The housing 21 includes a rotation-side housing 25 serving as one side, a stationary-side housing 26 serving as the other side, a bearing 27 being mounted on the stationary-side housing 26 and receiving the rotation-side housing 25 rotatably, and a seal mechanism 28 provided at a sliding portion between the rotation-side housing 25 and the stationary-side housing 26.

The rotation-side housing 25 includes an attachment flange 32 integrated with the rotation-side housing 25 by a plurality of bolts 31, and a ring gear 33, and a cover 35 integrated with the ring gear 33 by a fixing bolt (not illustrated). The rotation-side housing 25 is provided with cylinder-shaped rotation-side protrusion portion 36 protruding toward the stationary-side housing 26 at an edge facing the stationary-side housing 26. The rotation-side housing 25 is also provided with, at an attachment flange 32, the sprocket 15a for driving the crawler track 19 of the crawler vehicle. Therefore, around the rotation-side housing 25, the crawler track 19 of the driving device 11 is wound.

The stationary-side housing 26 is fixed to the crawler track frame 14 of the hydraulic excavator. To the stationary-side housing 26, the driving motor M is mounted. The stationary-side housing 26 includes a housing main body 38 formed in a cylinder shape, and has slits 39 on an outer periphery portion of the housing main body 38, the slits 39 being a plurality of notched openings.

At a center portion thereof, the housing main body 38 is provided with an engagement recess portion 41, in which an output shaft of the driving motor M is inserted. Moreover, the housing main body 38 integrally includes a cylindrical-shaped main body portion 43 having the engagement recess portion 41, and a flange portion 44 flanged from an outer periphery portion of the main body portion 43. The flange portion 44 is provided with cylindrical-shaped stationary-side protrusion portion 44a at an edge portion facing and protruding toward the rotation-side housing 25. The stationary-side protrusion portion 44a is provided at a position located outwardly away from the rotation-side protrusion 36. That is, the rotation-side protrusion portion 36 is inserted inwardly with respect to the stationary-side protrusion portion 44a, so that the stationary-side protrusion portion 44a and the rotation-side protrusion portion 36 face each other in a diameter direction of the housing 21 without touching each other.

The slits 39 are provided within the stationary-side protrusion 44a of the flange portion 44 of the housing main body 38. The slits 39 are provided radially in the diameter direction and communicate between an inside and an outside of the housing main body 38 (the stationary-side protrusion portion 44a). The slits 39 are provided in an area located in a lower half portion of the housing main body 38 (within stationary-side protrusion portion 44a) and preferably primarily along the rear edge in the driving direction. That is, the slits 39 are located at a position lower than a horizontal virtual line L1 passing through a center of the housing main body 38, and in a range of about 90° defined between the horizontal line L1 and a lower part of a vertical virtual line L2 passing through the center of the housing main body 38. In the other words, the slits 39 are located in a position near that part of the crawler track 19 which is wound around the rotation-side housing 25 (and sprocket 15a). Among the slits 39, a slit(s) located in the lower part of the housing main body 38 may be located forwardly with respect to the virtual line L2. That is, some slits 39 located in the lower portion may be located slightly forward of the vertical center of a lower edge portion of the housing main body 38. More specifically, in the present embodiment, the slits 39 are located in a range of the 3 o'clock position to the 7 o'clock position when viewed from the left hand side in the case of the final drive 15 on the left side of the hydraulic excavator. Thus, the slits 39 are preferably located in a range of the 5 o'clock position to the 9 o'clock position when viewed from the right hand side in the case of the final drive 15 on the right side of the hydraulic excavator.

The deceleration mechanism 22 is configured to perform decelerated transmission of rotation outputted from the driving motor M mounted in the stationary-side housing 26, to the crawler track 19 wound around the sprocket 15a attached to the rotation-side housing 25. The deceleration mechanism 22 may be a planetary gear-type deceleration mechanism, and is connected with the output shaft of the driving motor M, the output shaft being inserted in the engagement recess 41. Moreover, in the deceleration mechanism 22, lubricant oil is sealed inside the ring gear 33.

The seal mechanism 28 is configured to facilitate prevention of oil leakage from the inside to the outside of the rotation-side housing 25, and foreign material invasion from the outside to the inside of the housing 21, and includes a floating seal 51 serving as a seal portion, and a labyrinth channel 52 constituting a labyrinth seal portion.

The floating seal 51 is configured to seal a gap between the rotation-side housing 25 and the stationary-side housing 26. The floating seal 51 includes metal rings 54a and 54b made of a metal and O rings 55a and 55b made of, for example, synthetic resin.

The metal rings 54a and 54b have fine-fabricated and highly rigid sliding surfaces 57a and 57b, respectively, and hold the O rings 55a and 55b on their outer periphery sides.

The floating seal 51 is configured such that the fine-fabricated sliding surfaces 57a and 57b inside the metal rings 54a and 54b closely contact with each other due to pressing pressure of the O ring 55a pressed into a gap between the metal ring 54a and the rotation-side housing 25 (an internal circumferential surface of the rotation-side protrusion portion 36), and due to pressing pressure of the O ring 55a pressed into a gap between the metal ring 54b and the stationary-side housing 26 (an internal circumferential surface of the flange portion 44), and seal function is realized by the close contact, thereby preventing the leakage of the oil contained inside the rotation-side housing 25.

The labyrinth channel 52 is a space portion bent in a zigzag configuration back and forth between the rotation-side protrusion portion 36 of the rotation-side housing 25 and the stationary-side protrusion portion 44a of the stationary-side housing 26. The labyrinth channel 52 communicates with a position outside of the floating seal 51. The labyrinth channel 52 prevents relatively large foreign materials from invading to reach the floating seal 51 and reduces invasion of relatively small foreign materials reaching the floating seal 51. Moreover, the labyrinth channel 52 communicates with each slit 39 of the stationary-side housing 26, and with the outside of the housing 21 via the slits 39.

### INDUSTRIAL APPLICABILITY

Next, an effect of the embodiment thus illustrated. With the configuration in which the labyrinth channel 52 communicates with a position facing the floating seal 51 sealing the gap between the rotation-side housing 25 and the stationary-side housing 26, it becomes difficult for materials such as muddy water, mud, and small-particle soils to invade to reach floating seal 51 located at a far end of the labyrinth channel 52, even if the driving device 11 of the hydraulic excavator HE splashes the materials such as muddy water, mud, and small-particle soils up when running on a road with such materials.

Moreover, even if such materials such as muddy water, mud, and small-particle soils reach the far end of the labyrinth channel 52, the slits 39 communicating the labyrinth channel 52 and the outside of the stationary-side housing 26 facilitates the discharge of the materials, thereby reducing tendency of damaging the floating seal 51.

However, the configuration in which the slits for communicating the labyrinth channel 52 with the outside of the stationary-side housing 26 are simply provided does not eliminate a case of invasion of small stones or the like.

To solve this problem, according to the embodiment, the slits 39 for discharging out foreign materials are provided primarily only in the rear edge portion in the driving direction in the lower half of the housing main body 31. Foreign materials, for example, small stones carried from below the front edge portion by the crawler track 19, and mud or rigid foreign materials falling from the crawler track 19 located thereabove can be reduced without using an additional protecting member, or the like. Thus, the invasion of foreign materials into the labyrinth channel 52 can be reduced by using such a simple configuration, and foreign materials invaded into the labyrinth channel 52 can be easily discharged out via the slits 39.

Moreover, the slits 39 extended radially in the diameter directions of the housing main body 31 make it easier to discharge out foreign materials invaded into the labyrinth channel 52. Therefore, seal damage to the floating seal 51 associated with foreign material invasion into the labyrinth channel 52 can be reduced effectively.

Thus, by housing the deceleration mechanism 22 in the housing 21, the seal damage to the floating seal 51 associated with the foreign material invasion can be reduced, thereby reducing oil leakage resulted from such seal damage and consequently securing reliability of the final drive 15.

According to the embodiment, the driving device 11 is also applicable to any crawler vehicles, for example, ones for agricultural use, apart from the hydraulic excavator HE.

We claim:

1. A housing for a final drive, the housing being configured to be positioned at one edge portion of a driving device of a crawler vehicle in a driving direction and for housing a deceleration mechanism for decelerated transmission of a rotation of a driving motor to a crawler track, comprising:
a stationary-side housing;
a rotation-side housing provided rotatably with respect to the stationary-side housing and configured such that the crawler track of the driving device is wound around the rotation-side housing;
a seal portion for sealing a gap between the stationary-side housing and a rotation-side housing; and
a labyrinth channel provided at a position corresponding to the seal portion,
the stationary-side housing having:
a cylinder-shaped housing main body located coaxially with a rotation shaft of the rotation-side housing; and
a plurality of openings for discharging foreign materials, the plurality of openings being provided only in a lower half portion of the housing main body.

2. A housing as set forth in claim 1, wherein the plurality of openings include openings provided primarily in a rear edge in the driving direction in the lower half portion of the housing main body.

3. A housing as set forth in claim 1, wherein the plurality of openings are slits extended radically along diameter directions of the housing main body.

4. A final drive comprising:
a deceleration mechanism for decelerating a rotation speed of a driving motor; and
a housing as set forth in claim 1, for housing the deceleration mechanism.
